(19) United States
(12) Patent Application Publication
(10) Pub. No.: US 2025/0286790 A1
(43) Pub. Date: Sep. 11, 2025

(54) TECHNIQUES FOR DETECTING ANOMALOUS POLICIES IN A VIRTUALIZED NETWORK

(71) Applicant: Lenovo (United States) Inc., Morrisville, NC (US)

(72) Inventors: Souvik Paul, Stuttgart (DE); Sheeba Backia Mary Baskaran, Friedrichsdorf (DE)

(21) Appl. No.: 19/213,751

(22) Filed: May 20, 2025

(51) Int. Cl. H04L 41/16; H04L 41/0895; H04L 43/062

(52) U.S. Cl. CPC H04L 41/16; H04L 41/0895; H04L 43/062

(57) ABSTRACT

Various aspects of the present disclosure relate to techniques for detecting anomalous policies in a virtualized network. A network entity is configured to receive policy information associated with a policy for a network function virtualization (NFV)-enabled wireless network; analyze the policy information using a machine learning model to generate results, wherein the machine learning model is trained to identify anomalies in one or more policies; and transmit the results of the machine learning model analysis, the results comprising an indication of whether the policy comprises an anomaly.

### TECHNICAL FIELD

The present disclosure relates to wireless communications, and more specifically to techniques for detecting anomalous policies in a virtualized network.

BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE for wireless communication is described. The NE may be configured to, capable of, or operable to receive policy information associated with a policy for a network function virtualization (NFV)-enabled wireless network, analyze the policy information using a machine learning model to generate results, wherein the machine learning model is trained to identify anomalies in one or more policies, and transmit the results of the machine learning model analysis, the results comprising an indication of whether the policy includes an anomaly.

A processor for wireless communication is described. The processor may be configured to, capable of, or operable to receive policy information associated with a policy for a NFV-enabled wireless network, analyze the policy information using a machine learning model to generate results, wherein the machine learning model is trained to identify anomalies in one or more policies, and transmit the results of the machine learning model analysis, the results comprising an indication of whether the policy includes an anomaly.

A method for wireless communication performed by a NE is described. The method may be configured to, capable of, or operable to receive policy information associated with a policy for a NFV-enabled wireless network, analyze the policy information using a machine learning model to generate results, wherein the machine learning model is trained to identify anomalies in one or more policies, and transmit the results of the machine learning model analysis, the results comprising an indication of whether the policy includes an anomaly.

An NE for wireless communication is described. The NE may be configured to, capable of, or operable to transmit policy information associated with a policy for a NFV-enabled wireless network, receive an indication of whether the policy includes an anomaly, and receive an indication of whether the policy includes an anomaly.

A processor for wireless communication is described. The processor may be configured to, capable of, or operable to transmit policy information associated with a policy for a NFV-enabled wireless network, receive an indication of whether the policy includes an anomaly, and receive an indication of whether the policy includes an anomaly.

A method for wireless communication performed by a NE is described. The method may be configured to, capable of, or operable to transmit policy information associated with a policy for a NFV-enabled wireless network, receive an indication of whether the policy includes an anomaly, and receive an indication of whether the policy includes an anomaly.

### BRIEF DESCRIPTION OF THE DRAWINGS

FIG. 1 illustrates an example of a wireless communications system, in accordance with aspects of the present disclosure.

FIG. 2 illustrates an example process flow for policy verification, in accordance with aspects of the present disclosure.

FIG. 3 illustrates an example process flow for policy verification, in accordance with aspects of the present disclosure.

FIG. 4 depicts an example process flow for policy verification, in accordance with aspects of the present disclosure.

FIG. 5 illustrates an example of a UE, in accordance with aspects of the present disclosure.

FIG. 6 illustrates an example of a processor, in accordance with aspects of the present disclosure.

FIG. 7 illustrates an example of an NE, in accordance with aspects of the present disclosure.

FIG. 8 illustrates a flowchart of a method performed by an NE, in accordance with aspects of the present disclosure.

FIG. 9 illustrates a flowchart of a method performed by an NE, in accordance with aspects of the present disclosure.

### DETAILED DESCRIPTION

Generally, the present disclosure describes systems, methods, and apparatuses for techniques for detecting anomalous policies in a virtualized network. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In accordance with examples described herein, a virtualized network in a wireless communication system (e.g., a 5G or 6G communication system) includes a network architecture in which network functions traditionally executed on dedicated hardware are instead implemented as software instances operating on shared, general-purpose computing infrastructure. This virtualization is achieved through the combined use of Network Functions Virtualization (NFV) and Software-Defined Networking (SDN).

In some examples, a wireless communications system that employs a virtualized network and NFVs may use one or more operational policies for management of the virtualized network. These policies may function as blueprints for network configuration, performance management, security enforcement, and resource allocation. While traditionally authored by human network administrators, modern telco environments increasingly rely on automated policy generation through Zero-Touch Network and Service Management (ZSM) frameworks, including AI/ML-driven tools and large language models (LLMs).

However, such automation introduces new risks. In the presence of cyberattacks—such as Distributed Denial of Service (DDoS), routing manipulation, sinkhole attacks, direction misguidance, black hole attacks, flooding, Sybil attacks, spoofing—or even through misconfiguration or logic flaws, automated policies may result in improper network behavior, service degradation, or unauthorized data exposure. Orchestration compromise and unverified policy application may further propagate these vulnerabilities across multiple network functions.

Given these risks, the subject matter herein describes solutions that ensure the authenticity, integrity, and correctness of network policies prior to their application. The solutions describe verification mechanisms that are capable of validating both the source and contents of policies, particularly in dynamic and automated environments. Addressing these needs enhances reliability, availability, and trust in virtualized networks.

Aspects of the present disclosure are described in the context of a wireless communications system. Note that one or more aspects from different solutions may be combined.

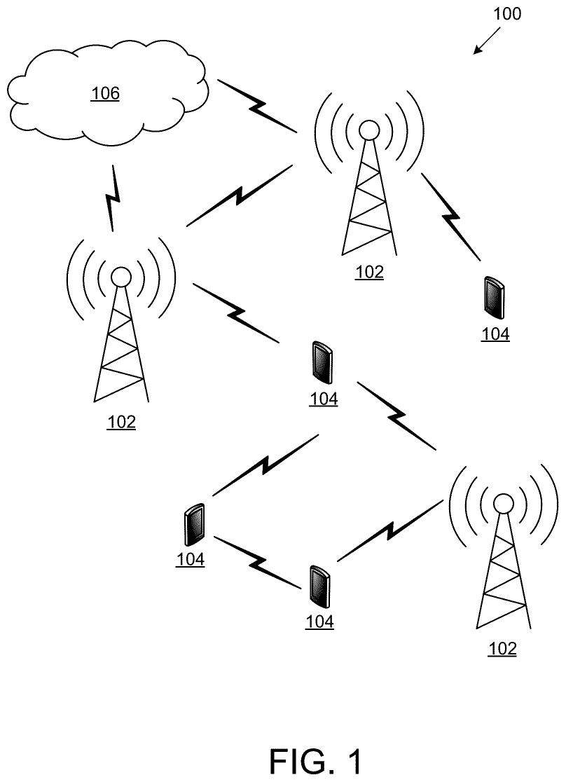

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In accordance with examples described herein, the wireless communications system 100 may utilize a virtualized network that includes a network architecture in which network functions traditionally executed on dedicated hardware are instead implemented as software instances operating on shared, general-purpose computing infrastructure. This virtualization is achieved through the combined use of Network Functions Virtualization (NFV) and Software-Defined Networking (SDN).

In wireless communications systems implementing NFV, key network elements such as baseband processing units, user plane functions (UPFs), session management functions (SMFs), and other core or edge network elements are instantiated as Virtual Network Functions (VNFs) or Cloud-Native Network Functions (CNFs). These functions are hosted in virtual machines or containers managed by a virtualization layer or container orchestration system (e.g., a hypervisor or Kubernetes platform), enabling dynamic scaling, relocation, and replication of network functions based on system demands.

In some examples, SDN is employed to separate the control plane from the data plane, allowing centralized control over traffic routing and management policies. The SDN controller communicates with network devices using standardized protocols (e.g., OpenFlow) to modify forwarding behavior programmatically in response to network conditions or service requirements.

This virtualized architecture supports the implementation of network slicing, where multiple logically independent networks (slices) are instantiated over a common physical infrastructure. Each slice may be tailored to meet specific performance or functional requirements, such as ultra-reliable low-latency communication (URLLC), enhanced mobile broadband (eMBB), or massive machine-type communications (mMTC).

Additionally, the virtualized architecture enables deployment of core or edge functions closer to the end user through Multi-access Edge Computing (MEC), thereby reducing latency and improving system responsiveness.

The use of virtualization in 5G systems provides numerous advantages including reduced capital and operational expenditures, increased deployment agility, improved fault tolerance, and enhanced scalability to accommodate evolving service demands.

With the evolution of telecommunications networks and the growing adoption of virtualization technologies, the core architecture of modern telecommunication (telco) systems has shifted from dedicated hardware-based implementations to software-driven, virtualized platforms. This transformation facilitates scalable deployment and simplified management of network functions by enabling stateless, cloud-native implementations of 3GPP-defined network functions (NFs).

In a virtualized 5G network, for example, deployment and lifecycle management of NFs are coordinated through a service orchestrator, which performs the essential Create, Read, Update, and Delete (CRUD) operations. These orchestrators typically operate within the NFV Management and Orchestration (NFV MANO) framework, as defined by the ETSI NFV reference architecture. NFV MANO is responsible for VNF on-boarding, instantiation, scaling, termination, and monitoring, in conjunction with integration to 3GPP-defined Operations Support Systems (OSS) and Business Support Systems (BSS).

NFV MANO systems interface with hypervisors or underlying host infrastructure and thereby can potentially access all operational and configuration data associated with VNFs. Without robust isolation or protection mechanisms, this level of access can create significant vulnerabilities. In particular, NFV MANO may serve as a single point of failure; if compromised, an adversary may manipulate, forge, or terminate VNFs, leading to service disruption, data loss, or security breaches.

A critical input to the NFV MANO system is the set of operational policies that govern the behavior of VNFs. These policies function as blueprints for network configuration, performance management, security enforcement, and resource allocation. While traditionally authored by human network administrators, modern telco environments increasingly rely on automated policy generation through Zero-Touch Network and Service Management (ZSM) frameworks, including AI/ML-driven tools and large language models (LLMs).

However, such automation introduces new risks. In the presence of cyberattacks—such as Distributed Denial of Service (DDoS), routing manipulation, sinkhole attacks, direction misguidance, black hole attacks, flooding, Sybil attacks, spoofing—or even through misconfiguration or logic flaws, automated policies may result in improper network behavior, service degradation, or unauthorized data exposure. Orchestration compromise and unverified policy application may further propagate these vulnerabilities across multiple network functions.

Given these risks, the subject matter herein describes solutions that ensure the authenticity, integrity, and correctness of network policies prior to their application by the MANO system. The solutions describe verification mechanisms that are capable of validating both the source and contents of policies, particularly in dynamic and automated environments. Addressing these needs enhances reliability, availability, and trust in virtualized networks, such as 5G core networks.

In one example, the system 100 may be used to implement techniques for detecting anomalous policies in a virtualized network. As described in more detail herein, the one or more NEs 102, one or more UEs 104, and CNs 106 in the system 100 may be used to identify one or more punctured resource blocks of a transmission block, determine a bandwidth of a transmission channel for the transmission block, move the one or more punctured resources blocks to one or more symbols of the transmission block in response to the bandwidth of the transmission channel being less than a threshold bandwidth, and transmit the transmission block, which may improve various characteristics of the NEs 102 and/or UEs 104 such as improved initial access procedures, improved signal reliability, improved resource utilization, improved energy efficiency, and improved latency. In this manner, signaling, battery life, and operational efficiencies in the NEs 102 and/or UEs 104 can be enhanced.

In accordance with aspects of the present disclosure, a Policy Verifier Function (PVF) is introduced as a security-enhancing mechanism for validating orchestration policies within a virtualized telecommunications network. This function is designed to detect anomalies in policies associated with Network Services (NS) and Virtual Network Functions (VNFs) through the application of Artificial Intelligence and Machine Learning (AI/ML) techniques. The PVF, for example, operates at various stages of network orchestration, including CRUD operations, as well as during the application of security configurations. It receives policy descriptors from orchestration components such as lifecycle management modules or network managers and evaluates them to determine whether the policies deviate from expected norms.

In one example, the internal architecture of the PVF consists of a sequence of operations. Upon receiving a policy input, a translation mechanism converts high-level policies into a lower-level format that can be interpreted by the system. A data extraction stage isolates key parameters and values required for analysis. These extracted data points are then passed to a machine learning module, which has been trained on a dataset composed of historical operator-specific policies and orchestration outcomes. The model generates inferences based on these inputs and produces vectorized outputs that reflect the policy's behavior or risk potential. A classification stage interprets the model's inference and delivers a structured decision in a human-readable format, often detailing which VNF or NS the anomaly affects and why the decision was made.

The example embodiments disclosed herein provide a proactive defense mechanism against misconfigurations and potential attacks that could exploit orchestration-level vulnerabilities. By validating policies prior to deployment, the PVF prevents erroneous or malicious configurations from being enacted, which might otherwise lead to the disruption of network services, the compromise of sensitive information, or inefficient use of resources. In an example, the solution uses historical network data not only to identify known anomalies but also to learn the behavioral patterns of legitimate operations, thus adapting to the specific needs and architecture of a given operator's environment. In doing so, the PVF enhances the reliability, security, and autonomy of cloud-native network operations and adds a layer of intelligence to traditional policy enforcement frameworks. Its application is not limited to core telco networks but extends to virtualized and container-based deployments across edge, access, and RAN domains, wherever orchestration integrity is needed.

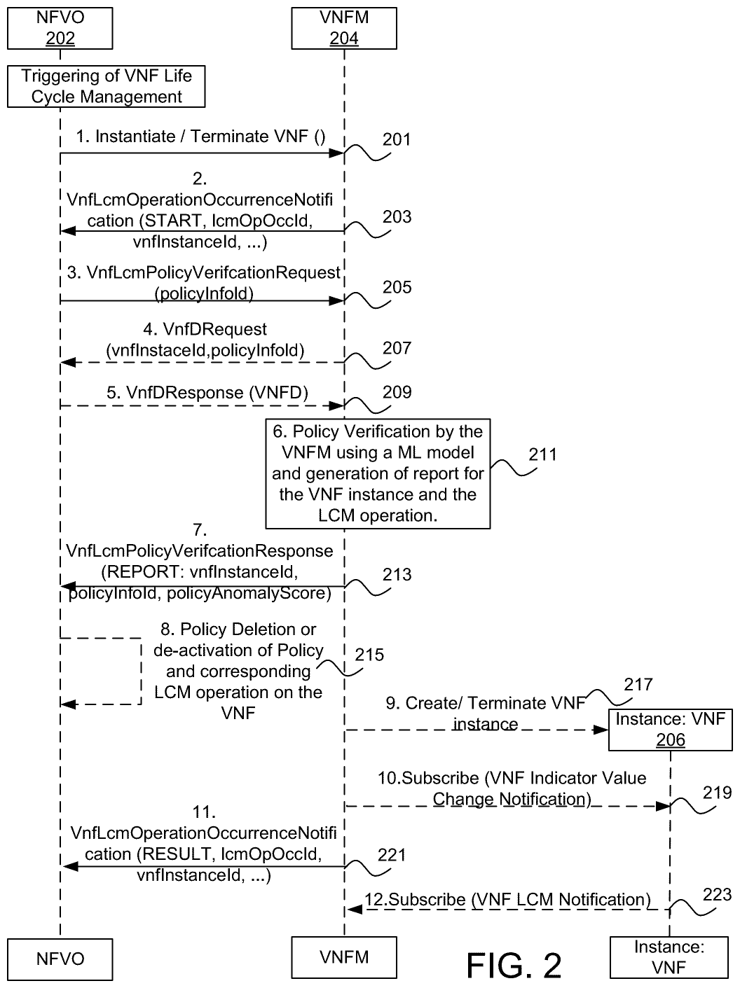

FIG. 2 illustrates an example process flow for policy verification, in accordance with aspects of the present disclosure. In this example, anomaly identification in the policies (or policy verification) is integrated as part of the VNF Manager (VNFM) and is utilized during a VNF lifecycle management operation—such as instantiation, scaling, updating, or termination—on a VNF. In one example, this integration ensures that policy compliance is continuously monitored and enforced throughout the VNF lifecycle. For example, during VNF instantiation, the VNFM verifies that the deployment policies conform to security and resource usage constraints. Similarly, during VNF termination, it checks for adherence to decommissioning policies, identifying any anomalies such as incomplete state cleanup or policy violations.

At 201, in one example, the NFV Orchestrator (NFVO) 202 receives a request to initiate a lifecycle management (LCM) operation on a VNF, such as instantiation or termination. The trigger mechanism for such LCM operations may originate from external systems such as a Network Manager (NM), Element Manager (EM), or Operations Support Systems/Business Support Systems (OSS/BSS), either via high-level policy directives or low-level configurations defined in a 3GPP Management System. In the depicted example, the step of VNF identifier creation is omitted for simplicity.

In one example, before proceeding with the VNF instantiation or termination, the NFVO 202 may optionally trigger a VnfLcmPolicy VerificationNotification if it has received low-level policies from an EM. The NFVO 202 will proceed with policy verification (205-215). The NFVO 202 will only execute 201 if the resulting policy AnomalyScore received in 213 is below a pre-configured threshold.

At 203, in one example, the VNFM 204, upon receiving the LCM operation request, initiates the corresponding operation and sends an operation occurrence notification, e.g., a VnfLcmOperationOccurrenceNotification to the NFVO 202 (and/or to any registered subscribers), indicating that the operation has begun. The notification may include operational metadata such as operation ID and vnfInstanceld.

At 205, in one example, upon receiving the LCM operation occurrence notification, the NFVO 202 maps the vnfInstanceld to a corresponding policyInfold and sends a VnfLcmPolicy VerificationNotification to the VNFM 204. This notification includes the policyInfold, which serves to identify the policy to be verified against the current VNF instance.

At 207, in one example, the VNFM 204 checks whether the Virtualized Network Function Descriptor (VNFD) associated with the specified vnfInstanceld and policyInfoId is available and accessible. If not available locally, the VNFM 204 issues a GET request to retrieve the VNFD from the “VNFD in an individual VNF package” resource in the NFV MANO system using a VnfdRequest. In one example, a precondition to this may be that the VNFM 204 have prior authorization to access the policy repository or VNFDs.

At 209, in one example, the VNFM 204 receives the VNFD as part of a vnfdResponse payload (e.g., following the retrieval mechanism described in ETSI GS NFV-SOL 003, Clause 10.3.2, which is incorporated herein by reference).

At 211, in one example, the VNFM 204 collects the policy corresponding to the policyInfoId and the VNFD associated with the vnfInstanceld, then performs policy translation. The translation step maps the VNF to a key-value data structure (VnfData), where the key is the vnfInstanceId, and the values include parameters and primitives derived from the policy and VNFD.

The VnfData is input into a machine learning (ML) model that is pre-trained by the operator using historical datasets of VNF lifecycle policies. In various examples, the model may use techniques such as One-Class SVM, Isolation Forest, or Autoencoders to perform anomaly detection. The output is a numerical value or score, policy AnomalyScore, indicating the presence of an anomaly (e.g., −1 for anomaly, 1 for normal), with possible extensions or variations to more granular scoring depending on implementation. Thresholds for anomaly detection may be user-defined or dynamically set based on the sensitivity of the VNF or network service involved.

In an example, the VNFM 204 generates a report, policy VerificationReport, which includes one or more of the vnfInstanceld, the policyInfold, the policy AnomalyScore, the policy VerificationExplanation (which is an optional human-readable rationale generated via generative or explainable AI methods), and/or the policy VerificationAction (e.g., the recommended policy adjustment). The report may be serialized in a structured format such as JSON and optionally stored in a dedicated database for cyber threat intelligence (CTI) analysis or auditing.

At 213, in one example, the VNFM 204 transmits the policy VerificationReport to the NFVO 202 and other relevant subscribers (e.g., EM/domain manager (DM)/OSS/BSS) in the form of a VnfLcmPolicy VerificationResponse to indicate whether there is any anomaly in the policy for the lifecycle management operation of the VNF.

At 215, in one example, if the policy AnomalyScore indicates an anomaly (e.g., exceeds or falls below a predefined threshold depending on scoring logic), the NFVO 202 aborts the LCM operation. The NFVO 202 may delete or deactivate the associated policy and send an alert to network administrators. This alert can include the policy VerificationExplanation and policy VerificationAction. In one example, additional subscribers such as EM or DM systems may also receive the anomaly alert from the NFVO 202 and take further action accordingly.

At 217, in one example, if the policy is verified as normal (e.g., no anomaly detected), the VNFM 204 proceeds to execute the LCM operation. For example, in the case of instantiation, it proceeds to create the VNF 206. Interactions between the VNFM 204 and the Virtualized Infrastructure Manager (VIM) for resource allocation are abstracted and not shown here for simplicity.

At 219, in one example, the VNFM 204 subscribes to VNF indicator value change notifications to monitor operational metrics or health indicators of the VNF 206.

At 221, in one example, upon completion of the VNF instantiation or termination, the VNFM 204 sends a VnfLcmOperationOccurrenceNotification to the NFVO 202 and subscribers, indicating the completion status and operation metadata.

At 223, in one example, the instantiated VNF 206 subscribes to receive VNF LCM notifications, enabling it to track subsequent lifecycle management events relevant to its operation.

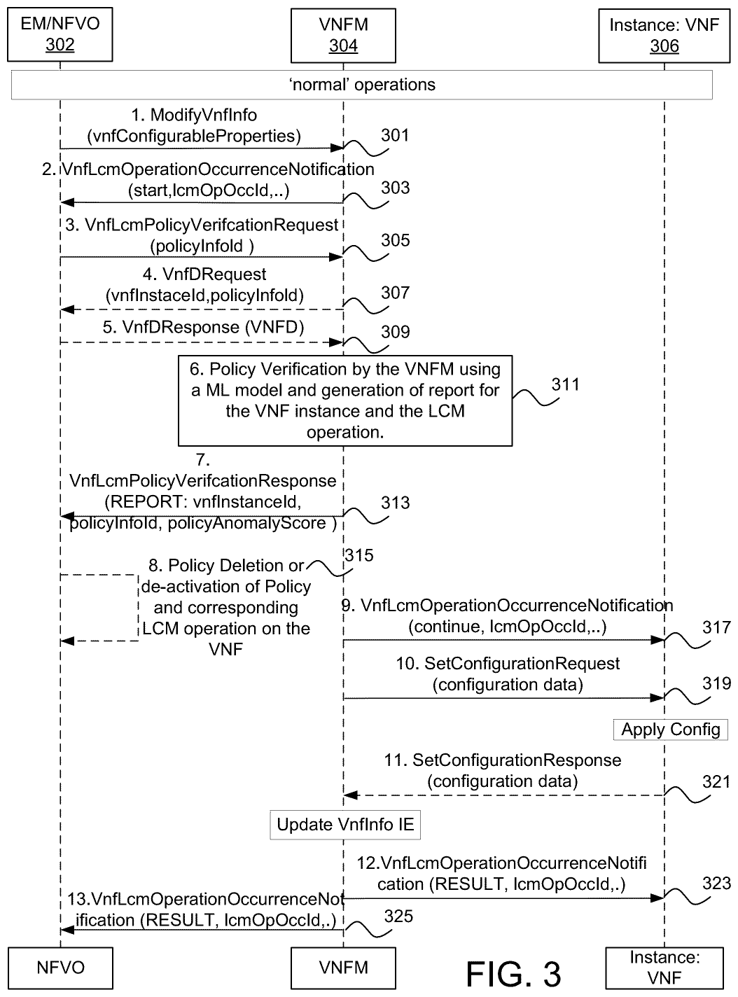

FIG. 3 illustrates an example process flow for policy verification, in accordance with aspects of the present disclosure. In this example, anomaly identification in the policies is integrated as a functional capability within the VNFM and is actively utilized during LCM operations involving modifications to VNF configurable properties. Such operations are executed via the VNF Configuration interface, e.g., as specified in Clause 6.2 of ETSI GS NFV-IFA 008 V5.2.1 (incorporated herein by reference). This policy verification mechanism enables proactive detection of policy inconsistencies or misconfigurations during runtime configuration changes, ensuring compliance with predefined operational, performance, and security constraints. As illustrated in FIG. 3, the policy anomaly detection is invoked as part of the VNF Configuration process.

At 301, in one example, the NFVO 302 transmits a Modify VnfInfo request to the VNFM 304, instructing it to modify one or more VNF configurable properties. The request includes the vnfConfigurableProperties parameter, which encapsulates the new configuration data to be applied to the target VNF instance.

In one example, such configuration change operations may be initiated by external entities—such as the EM, DM, or OSS/BSS—either through high-level policy triggers from a 3GPP-compliant management system or via low-level configuration directives.

In another example, if the configuration change is driven by a policy update or lifecycle management directive, the NFVO 302 or VNFM 304 (e.g., upon receiving low-level policies from the EM) may initiate a VnfLcmPolicy VerificationNotification procedure. In such cases, 305-315, described below, may be executed to perform policy anomaly detection before continuing with the configuration operation. If the resulting policy AnomalyScore is within acceptable thresholds in 313, the NFVO 302 proceeds with 301.

At 303, in one example, upon receiving the configuration change request, the VNFM 304 initiates the LCM operation and broadcasts a notification, e.g., VnfLcmOperationOccurrenceNotification, to the NFVO 302 and other registered subscribers. This message includes metadata such as the operation ID, vnfInstanceld, and an indication of the LCM operation's commencement.

At 305, in one example, the NFVO 302, upon receiving the LCM notification, maps the received vnfInstanceld to an associated policyInfold using internal or pre-configured policy mappings. It then issues a VnfLcmPolicy VerificationNotification to the VNFM 304, including the policyInfold and the vnfConfigurableProperties to be validated.

At 307, in one example, the VNFM 304 checks whether the VNFD and the relevant policy data corresponding to the vnfInstanceld and policyInfold are locally accessible. If not, the VNFM 304 issues a GET request to retrieve the VNFD from the appropriate VNF package resource, using the identifiers in a VnfdRequest. In an example, as a precondition, the VNFM 304 is authorized to access the VNFD and policy repositories managed within the NFV MANO framework.

At 309, in one example, the VNFM 304 receives the VNFD payload in the form of a vnfdResponse, e.g., following ETSI GS NFV-SOL 003, Clause 10.3.2.

At 311, in one example, the VNFM 304 aggregates the policy and VNFD data and constructs a low-level data structure (VnfData) representing the VNF configuration context. The VnfData is formatted as a key-value map, where the key is the vnfInstanceld, and the value contains configuration features, operational primitives, and policy-relevant parameters.

In one example, this structure is then submitted to a machine learning-based anomaly detection model (e.g., One-Class SVM, Isolation Forest, Autoencoder). The model, pre-trained using historical LCM operation data, outputs a policy AnomalyScore representing the likelihood of policy inconsistency or misconfiguration, e.g., −1 for anomaly and 1 for normal, where a threshold value is used as a parameter to the ML model during classification. The threshold can be integrated based on the severity of policy control measures for generating the policy AnomalyScore.

In addition, the VNFM 304 generates a policy VerificationReport that includes a vnfInstanceld, a policyInfold, a policy AnomalyScore, an optional policy VerificationExplanation (generated using Explainable AI methods), and an optional policy VerificationAction (suggested remediation or policy correction). The report may be serialized in formats such as JSON and stored in a database for future analysis or CTI generation.

In one example, the threshold value used by the ML model may vary based on service criticality or sensitivity. Further, anomaly scores may use binary, multi-class, or continuous values depending on implementation (instead of or in addition to using −1 and 1).

At 313, in one example, the VNFM 304 transmits the policy VerificationReport to the NFVO 302 and other subscribers (e.g., EM, DM, OSS/BSS) via a VnfLcmPolicy VerificationResponse message.

At 315, in one example, if the policy AnomalyScore exceeds the predefined anomaly threshold (i.e., indicates policy inconsistency), the NFVO 302 aborts the ongoing LCM operation. It may delete or deactivate the associated policy and issue an alert to network administrators, including the policy VerificationExplanation and policy VerificationAction.

In one example, downstream consumers (e.g., EM/DM) may also receive failure notifications or triggers.

At 317, in one example, if no anomaly is detected (i.e., the policy AnomalyScore is within acceptable bounds), the VNFM 304 proceeds with the requested configuration operation and sends a VnfLcmOperationOccurrenceNotification to the VNF 306, indicating the LCM operation's continuation.

At 319, in one example, the VNFM 304 invokes the SetConfigurationRequest operation on the VNF 306 via the VNF Configuration interface, passing the validated configuration data (vnfConfigurableProperties) as a parameter.

At 321, in one example, the VNF 306 processes the configuration request and applies the new settings. Upon completion, it responds to the VNFM 304 with a SetConfigurationResponse, confirming the successful application of the configuration and optionally returning the resulting state or final configuration set.

At 323, in one example, the VNFM 304 records the final status of the operation and transmits a VnfLcmOperationOccurrenceNotification to the VNF 306, indicating the LCM operation result and operation ID.

At 325, in one example, the VNFM 304 completes the operation by sending a conclusive VnfLcmOperationOccurrenceNotification to the NFVO 302 and all registered subscribers, confirming the successful execution (or termination) of the configuration change operation.

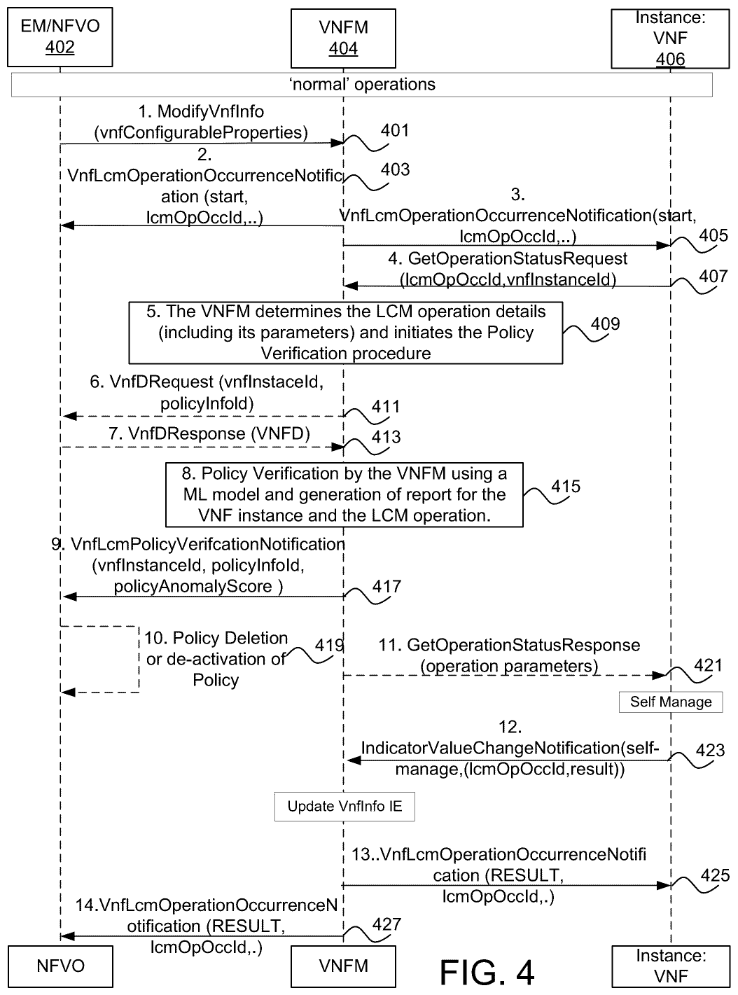

FIG. 4 depicts an example process flow for policy verification, in accordance with aspects of the present disclosure. In this example, anomaly identification in the policies—also referred to as policy verification—is implemented as an integrated function within the VNFM and is invoked during VNF lifecycle management operations involving changes to VNF configurable properties, without utilizing the VNF Configuration interface, e.g., as defined in Clause 6.2 of ETSI GS NFV-IFA 008 V5.2.1. This example is applicable to VNFs that possess self-management capabilities, such as autonomous configuration, self-healing, or self-optimization logic embedded within the VNF itself.

In this example, the VNF independently initiates configuration changes internally or based on policy-driven triggers from its own embedded management logic. The VNFM is notified of such changes as part of standard lifecycle management event flows (e.g., Modify VnfInfo or VNF indicator notifications). Upon receiving such an event, the VNFM performs policy anomaly detection using the associated policy definitions and the reported or inferred configuration parameters, without requiring a SetConfigurationRequest/Response exchange.

The policy verification process may be triggered during operations such as Modify VnfInfo, ScaleToLevel, or ChangeExternalConnectivity, and uses pre-trained machine learning models to evaluate the configuration change context. If an anomaly is detected (e.g., unauthorized parameter adjustment, policy non-compliance, or deviation from service-level objectives), the VNFM can generate a policy verification report and notify the NFVO or other subscribed management entities. Depending on the anomaly score and severity, corrective measures—such as policy rollback, alert generation, or configuration override—may be applied automatically or recommended to human operators.

This example may be particularly relevant for next-generation VNFs that support AI-based closed-loop automation and require real-time policy compliance checks without relying on direct configuration interfaces.

At 401, in one example, an NFVO 402 transmits a Modify VnfInfo operation to the VNFM 404, requesting the modification of specific VNF configurable properties. The request includes a parameter vnfConfigurableProperties, which defines the targeted configuration values to be updated within the VNF instance. In one example, this step may be initiated by the NFVO 402 based on a request from higher-level systems such as the EM, DM, or the OSS/BSS. These systems may provide high-level policy inputs, particularly from a 3GPP-aligned management system, to drive reconfiguration or optimization of VNF behavior.

At 403, in one example, upon receiving the request, the VNFM 404 begins execution of the LCM operation and notifies the NFVO 402 and subscribed entities by issuing a VnfLcmOperationOccurrenceNotification. This notification contains the operation type, the associated vnfInstanceld, a unique lcmOpOccId, timestamps, and operation state (e.g., STARTING).

At 405, in one example, the VNFM 404 transmits the VnfLcmOperationOccurrenceNotification to the corresponding VNF 406 to inform it that an LCM operation has commenced. This is important in self-managed VNFs that do not rely on the standard VNF Configuration Interface for external configuration.

At 407, in one example, in scenarios where the VNF 406 has been designed with internal (self-managing) capabilities and does not utilize the standard configuration interface (e.g., as described in ETSI GS NFV-IFA 008, Clause 6.2 (incorporated herein by reference)), the VNF 406 actively queries the VNFM 404 by sending a GetOperationStatusRequest. This request includes the lcmOpOccId to retrieve details about the ongoing operation it is expected to perform.

At 409, in one example, the VNFM 404, in response, uses the lcmOpOccId and vnfInstanceld to retrieve the parameters associated with the operation. These parameters may include the full context of the operation such as configuration deltas, policy references, and expected behavioral constraints. This data acts as a precursor to initiating policy verification.

At 411, in one example, the VNFM 404 verifies whether the VNFD corresponding to the vnfInstanceld and policyInfold is available locally. If not accessible, it sends a GET request to the NFVO 402 targeting the resource containing the VNFD within the on-boarded VNF package. This request, known as a VnfdRequest, uses the URI of the resource and includes both vnfInstanceId and policyInfold to identify the correct package and version. As a precondition, in one example, the VNFM 404 is authorized and pre-configured to access or request policy-related artifacts from the NFVO 402, including the policy repository or package contents in NFV MANO.

At 413, in one example, the NFVO 402 returns the VNFD in a vnfdResponse, e.g., as defined in ETSI GS NFV-SOL 003 (Clause 10.3.2). This descriptor includes metadata about the VNF such as lifecycle operations, virtual deployment units (VDUs), VNF indicators, monitoring parameters, and configuration primitives.

At 415, in one example, the VNFM 404 performs a policy translation operation where it correlates the received policy data and VNFD information into a structured internal format called VnfData. This format includes the VNF instance identifier as a key and features such as constraints, permitted parameter values, policy definitions, and behavior models as values. This structured VnfData is input to a Machine Learning (ML) model for policy anomaly detection. The model may be a one-class classifier (e.g., One-Class SVM), an ensemble method (e.g., Isolation Forest), or an unsupervised neural network (e.g., Autoencoder).

The ML model evaluates the input and generates a policy AnomalyScore, which may range from binary values like −1 for anomaly and 1 for normal behavior, or a continuous score that is compared against a predefined threshold configured by the operator. In addition, the VNFM 404 creates a policy VerificationReport that includes policy InfoId, vnfInstanceId, policy AnomalyScore, a human-readable explanation of the score (policy VerificationExplanation), an optionally generated using explainable AI techniques, and a suggested corrective action (policy VerificationAction) such as replacing or rewriting the policy. In one example, as a precondition, the ML model is trained on historical VNF lifecycle data, such as CRUD operations, to learn the normal behavioral patterns and detect deviations. In one example, the anomaly threshold is tunable per VNF or network slice, allowing operators to control sensitivity. In another example, implementations may define the policy AnomalyScore on a probabilistic or normalized scale, not limited to discrete values, such as −1 and 1.

At 417, in one example, the VNFM 404 sends the policy VerificationReport to the NFVO 402 and to other subscribing systems such as EM, DM, OSS, or BSS, using a VnfLcmPolicy VerificationNotification. The report encapsulates the evaluation results to inform decision-making regarding the continuation or termination of the VNF LCM operation. If an anomaly is detected (e.g., if policy AnomalyScore exceeds the anomaly threshold), 419 is executed. If the score is within the acceptable range, the operation continues to 421.

At 419, in one example, upon confirmation of a policy anomaly, the NFVO 402 initiates deletion, termination, or rollback of the active LCM operation and/or deactivates the policy responsible. Furthermore, the NFVO 402 may alert the network administrator or upstream management system, supplying the policy VerificationExplanation and policy VerificationAction for contextual understanding and manual intervention if required. In such cases, downstream systems such as the EM/DM can be alerted of the termination and the root cause.

At 421, in one example, if no anomaly is detected, the VNFM 404 responds to the VNF's 406 earlier request with a GetOperationStatusResponse, providing the necessary lifecycle operation details, including any parameters that the VNF 406 requires to apply configuration changes on its own.

At 423, in one example, the self-managing VNF 406 autonomously performs the required configuration changes using internal logic and capabilities defined by the provider. Upon successful application, the VNF 406 sends an Indicator ValueChangeNotification back to the VNFM 404. This message indicates that the configuration changes have been applied successfully and includes a VNF Indicator, whose format is defined in the VNFD.

At 425, in one example, the VNFM 404 updates the VnfInfo internal data structure to reflect the VNF's 406 new configuration state, incorporating any changes notified via the indicator message.

At 427, in one example, the VNFM 404 issues a final VnfLcmOperationOccurrenceNotification to the VNF 406 and all subscribers, confirming successful completion of the operation, operation ID, and final result (e.g., COMPLETED, SUCCEEDED).

At 429, in one example, to conclude, the VNFM 404 transmits the corresponding VnfLcmOperationOccurrenceNotification to the NFVO 402, signaling that the lifecycle operation has been successfully executed and closed.

In one example, alternatively or in conjunction with the described examples, the proposed AI-driven policy verification mechanism may be integrated into various components of the NFV architecture. Specifically, the policy verification function can be deployed as part of (1) the EM, where it operates as a policy control or validation function, (2) the NFVO, enabling centralized policy assessment across multiple VNFs or network services, or (3) as a standalone, dedicated entity within MANO framework. Furthermore, the instantiation or activation of the policy verification process may be triggered selectively in response to critical configuration changes involving sensitive VNFs or network services (NS), where misconfigurations or policy violations could have significant operational or security impact.

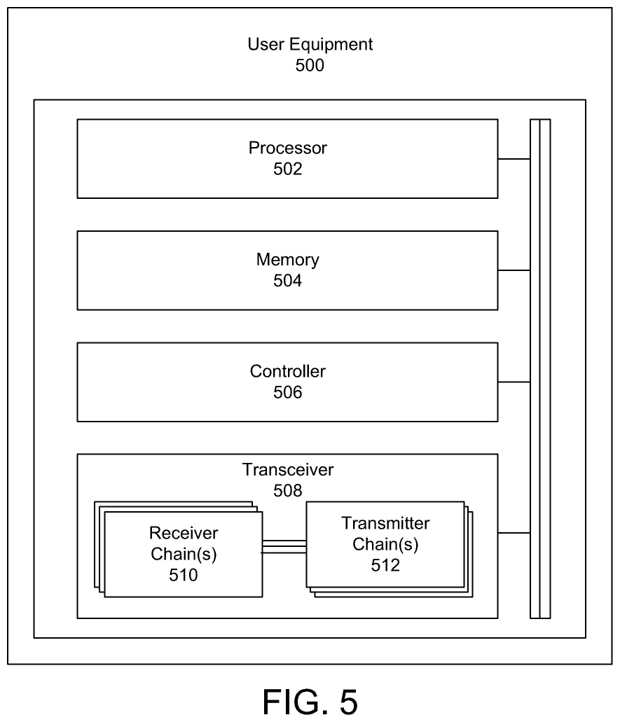

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, the UE 500 is configured to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

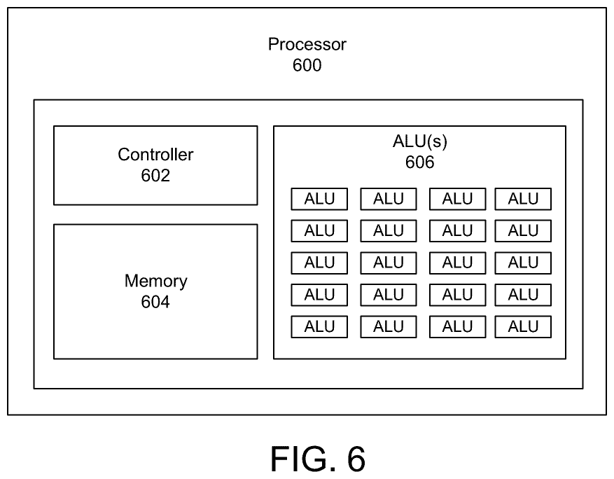

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, a processor 600 is configured to receive policy information associated with a policy for NFV enabled wireless network, analyze the policy information using a machine learning model to generate results, wherein the machine learning model is trained to identify anomalies in one or more policies, and transmit the results of the machine learning model analysis, the results comprising an indication of whether the policy includes an anomaly.

In one example, the policy information includes the policy and a corresponding VNFD. In one example, the processor 600 is configured to generate a data structure based on the policy information, the data structure provided to the machine learning model for analysis. In one example, the data structure includes a key-value pair based on the policy information, wherein the key includes an identifier for a virtual network function and the value includes data from the policy and the VNFD. In one example, the data from the policy and the VNFD includes parameters and primitives associated with the policy and the VNFD.

In one example, the indication of whether the policy includes an anomaly includes a score that is determined according to a score threshold. In one example, the processor 600 is configured to generate a report comprising the results of the machine learning analysis and transmit the report. In one example, the processor 600 is configured to generate an explanation of the results of the machine learning analysis using the machine learning model.

In one example, the processor 600 is configured to generate one or more policy recommendations, using the machine learning model, based on the results of the machine learning analysis. In one example, the processor 600 is configured to train the machine learning model using historical policy information associated with NFV-enabled wireless networks.

In one example, the historical policy information includes policy information associated with historical VNF management operations. In one example, the historical VNF management operations include operations associated with VNF creation, reading, updating, deletion, scaling-up, scaling to level, instantiation, termination, or a combination thereof.

In one example, the processor 600 is pre-authorized to access policies associated with the NFV-enabled wireless network. In one example, the processor 600 includes a VNFM.

In one example, the processor 600 is configured to transmit policy information associated with a policy for a NFV-enabled wireless network, receive an indication of whether the policy includes an anomaly, and deactivate the policy in response to the indication indicating that the policy includes an anomaly.

In one example, the processor 600 is configured to request instantiation of a virtual network function associated with the policy. In one example, the processor 600 is configured to request verification of the policy. In one example, the policy information includes the policy and a corresponding VNFD.

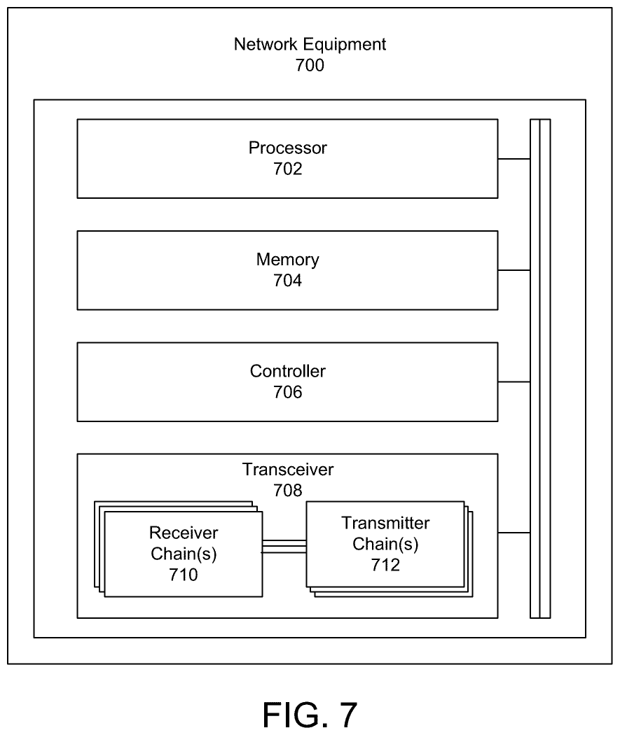

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, a NE 700 is configured to receive policy information associated with a policy for NFV enabled wireless network, analyze the policy information using a machine learning model to generate results, wherein the machine learning model is trained to identify anomalies in one or more policies, and transmit the results of the machine learning model analysis, the results comprising an indication of whether the policy includes an anomaly.

In one example, the policy information includes the policy and a corresponding VNFD. In one example, the NE 700 is configured to generate a data structure based on the policy information, the data structure provided to the machine learning model for analysis. In one example, the data structure includes a key-value pair based on the policy information, wherein the key includes an identifier for a virtual network function and the value includes data from the policy and the VNFD. In one example, the data from the policy and the VNFD includes parameters and primitives associated with the policy and the VNFD.

In one example, the indication of whether the policy includes an anomaly includes a score that is determined according to a score threshold. In one example, the NE 700 is configured to generate a report comprising the results of the machine learning analysis and transmit the report. In one example, the NE 700 is configured to generate an explanation of the results of the machine learning analysis using the machine learning model.

In one example, the NE 700 is configured to generate one or more policy recommendations, using the machine learning model, based on the results of the machine learning analysis. In one example, the NE 700 is configured to train the machine learning model using historical policy information associated with NFV-enabled wireless networks.

In one example, the historical policy information includes policy information associated with historical VNF management operations. In one example, the historical VNF management operations include operations associated with VNF creation, reading, updating, deletion, scaling-up, scaling to level, instantiation, termination, or a combination thereof.

In one example, the NE 700 is pre-authorized to access policies associated with the NFV-enabled wireless network. In one example, the NE 700 includes a VNFM.

In one example, the NE 700 is configured to transmit policy information associated with a policy for a NFV-enabled wireless network, receive an indication of whether the policy includes an anomaly, and deactivate the policy in response to the indication indicating that the policy includes an anomaly.

In one example, the NE 700 is configured to request instantiation of a virtual network function associated with the policy. In one example, the NE 700 is configured to request verification of the policy. In one example, the policy information includes the policy and a corresponding VNFD.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

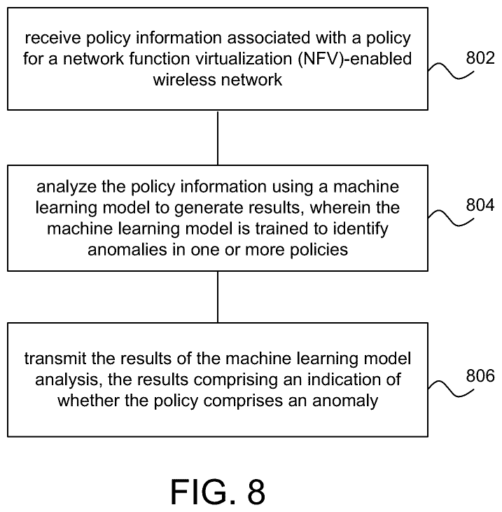

FIG. 8 illustrates a flowchart of a method performed by an NE 700 in accordance with aspects of the present disclosure. The operations of the method may be implemented by a NE 700 as described herein. In some implementations, the NE 700 may execute a set of instructions to control the function elements of the NE 700 to perform the described functions.

At step 802, the method may receive policy information associated with a policy for a NFV-enabled wireless network. The operations of step 802 may be performed in accordance with examples as described herein. In some implementations, aspects of the operations of step 802 may be performed by a NE 700, as described with reference to FIG. 7.

At step 804, the method may analyze the policy information using a machine learning model to generate results, wherein the machine learning model is trained to identify anomalies in one or more policies. The operations of step 804 may be performed in accordance with examples as described herein. In some implementations, aspects of the operations of step 804 may be performed by a NE 700, as described with reference to FIG. 7.

At step 806, the method may transmit the results of the machine learning model analysis, the results comprising an indication of whether the policy includes an anomaly. The operations of step 806 may be performed in accordance with examples as described herein. In some implementations, aspects of the operations of step 806 may be performed by a NE 700, as described with reference to FIG. 7.

It should be noted that the method described herein describes one possible implementation, and that the operations and the steps may be rearranged or otherwise modified and that other implementations are possible.

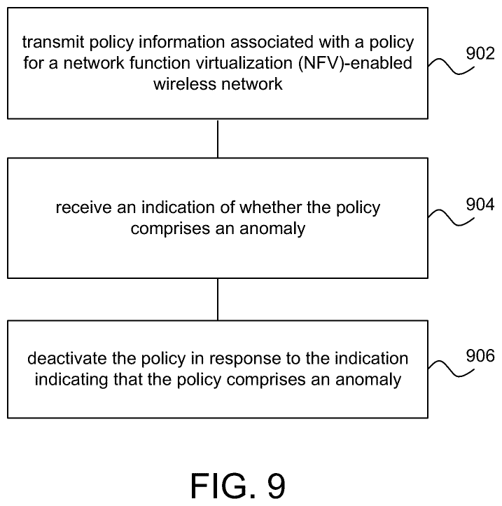

FIG. 9 illustrates a flowchart of a method performed by an NE 700 in accordance with aspects of the present disclosure. The operations of the method may be implemented by a NE 700 as described herein. In some implementations, the NE 700 may execute a set of instructions to control the function elements of the NE 700 to perform the described functions.

At step 902, the method may transmit policy information associated with a policy for a NFV-enabled wireless network. The operations of step 902 may be performed in accordance with examples as described herein. In some implementations, aspects of the operations of step 902 may be performed by a NE 700, as described with reference to FIG. 7.

At step 904, the method may receive an indication of whether the policy includes an anomaly. The operations of step 904 may be performed in accordance with examples as described herein. In some implementations, aspects of the operations of step 904 may be performed by a NE 700, as described with reference to FIG. 7.

At step 906, the method may deactivate the policy in response to the indication indicating that the policy includes an anomaly. The operations of step 906 may be performed in accordance with examples as described herein. In some implementations, aspects of the operations of step 906 may be performed by a NE 700, as described with reference to FIG. 7.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
receive policy information associated with a policy for a network function virtualization (NFV)-enabled wireless network;
analyze the policy information using a machine learning model to generate results, wherein the machine learning model is trained to identify anomalies in one or more policies; and
transmit the results of the machine learning model analysis, the results comprising an indication of whether the policy comprises an anomaly.

2. The NE of claim 1, wherein the policy information comprises the policy and a corresponding virtual network function descriptor (VNFD).

3. The NE of claim 2, wherein the at least one processor is configured to cause the NE to generate a data structure based on the policy information, the data structure provided to the machine learning model for the analysis.

4. The NE of claim 3, wherein the data structure comprises a key-value pair based on the policy information, wherein a key of the key-value pair comprises an identifier for a virtual network function and a value of the key-value pair comprises data from the policy and the VNFD.

5. The NE of claim 4, wherein the data from the policy and the VNFD comprises parameters and primitives associated with the policy and the VNFD.

6. The NE of claim 1, wherein the indication of whether the policy comprises an anomaly comprises a score that is determined according to a score threshold.

7. The NE of claim 1, wherein the at least one processor is configured to cause the NE to generate a report comprising the results of the machine learning analysis and transmit the report.

8. The NE of claim 7, wherein the at least one processor is configured to cause the NE to generate an explanation of the results of the machine learning analysis using the machine learning model.

9. The NE of claim 1, wherein the at least one processor is configured to cause the NE to generate one or more policy recommendations, using the machine learning model, based on the results of the machine learning analysis.

10. The NE of claim 1, wherein the at least one processor is configured to cause the NE to train the machine learning model using historical policy information associated with NFV-enabled wireless networks.

11. The NE of claim 10, wherein the historical policy information comprises policy information associated with historical virtual network function (VNF) management operations.

12. The NE of claim 11, wherein the historical VNF management operations comprise operations associated with VNF creation, reading, updating, deletion, scaling-up, scaling to level, instantiation, termination, or a combination thereof.

13. The NE of claim 1, wherein the NE is pre-authorized to access policies associated with the NFV-enabled wireless network.

14. The NE of claim 1, wherein the NE comprises a virtual network function manager (VNFM).

15. A method of a network equipment (NE), comprising:
receiving policy information associated with a policy for a network function virtualization (NFV)-enabled wireless network;
analyzing the policy information using a machine learning model to generate results, wherein the machine learning model is trained to identify anomalies in one or more policies; and
transmitting the results of the machine learning model analysis, the results comprising an indication of whether the policy comprises an anomaly.

16. A network equipment (NE) for wireless communication, comprising:
at least one memory; and
at least one processor coupled with the at least one memory and configured to cause the NE to:
transmit policy information associated with a policy for a network function virtualization (NFV)-enabled wireless network;
receive an indication of whether the policy comprises an anomaly; and
deactivate the policy in response to the indication indicating that the policy comprises an anomaly.

17. The NE of claim 16, wherein the at least one processor is configured to cause the NE to request instantiation of a virtual network function associated with the policy.

18. The NE of claim 16, wherein the at least one processor is configured to cause the NE to request verification of the policy.

19. The NE of claim 16, wherein the policy information comprises the policy and a corresponding virtual network function descriptor (VNFD).

20. A method of a network equipment (NE), comprising:
transmitting policy information associated with a policy for a network function virtualization (NFV)-enabled wireless network;
receiving an indication of whether the policy comprises an anomaly; and
deactivating the policy in response to the indication indicating that the policy comprises an anomaly.
